(19) United States
(12) Patent Application Publication
(10) Pub. No.: US 2015/0211761 A1
(43) Pub. Date: Jul. 30, 2015

(54) METHOD OF AUTOMATING A BUILDING, AND BUILDING AUTOMATION SYSTEM

(71) Applicant: SIEMENS SCHWEIZ AG, Zuerich (CH)

(72) Inventors: JONATHAN MILES COPLEY, ZUG (CH); KOLJA EGER, WEDEMARK/MELLENDORF (DE); JOERG HAMMER, HUENENBERG (CH); VIVEK KULKARNI, UNTERHACHING (DE)

(21) Appl. No.: 14/609,946

(22) Filed: Jan. 30, 2015

(30) Foreign Application Priority Data
Jan. 30, 2014 (EP) 14153345.5

(51) Int. Cl. F24F 11/00; G05B 15/02

(52) U.S. Cl. CPC F24F 11/006; G05B 15/02

(57) ABSTRACT

In a building automation system, a method for automating a building includes a step of acquiring at least one data time history from a sensor or from a meter. The data time history is averaged and the averaged data time history is fitted into at least one occupancy pattern. The occupancy pattern covers a given time span. At least one set point is determined from the occupancy pattern and the at least one set point is fed into a system for heating, ventilation, and/or air-conditioning. In the novel system the at least one data time history is acquired from an element of standard infrastructure.

### CROSS-REFERENCE TO RELATED APPLICATION

This application claims the priority, under 35 U.S.C. §119, of European patent application EP 14153345.5, filed Jan. 30, 2014; the prior application is herewith incorporated by reference in its entirety.

### BACKGROUND OF THE INVENTION

### Field of the Invention

The present disclosure relates to an improved building automation system. The present disclosure focuses on a building automation system that relies on a plurality of readings from electricity and water consumption meters as well as from temperature, humidity, and/or other sensors.

Data from meters, from sensors, and from other devices in buildings are increasingly made available to cloud server applications via home or smart meter gateways. Access to these data yields new value adding applications as well as business models. They frequently harness the recognition of occupancy and behavioral patterns in residential, commercial or industrial buildings.

Recognition of occupancy and behavioral patterns can be utilized for optimization purposes. Optimization in this case applies to building and home automation including HVAC (heating, ventilation, and air conditioning), lighting, safety & security, as well as assisted living.

Deviations from normal behavioral patterns could, for instance, be: the opening of a door or of a window at an unexpected time of the day, an unexpected temperature rise or fall or noise due to footsteps, the improbable presence of a mobile device as detected by a router, or any other unforeseen sensor readings. A detection of one or of a series of unexpected events may be used to alert occupants (e.g. via text message, via email, or via social media). It may also result in follow-up action such as inspection of the interior or entrance door through a web camera. Similarly, behavioral deviations may be used in the context of assisted living for alerting relatives or careers when an occupant appears ill or immobilized.

Other deviations from expected behavior such as no sign of life at the times usually expected may indicate that occupants are absent. The heating, ventilation, and air conditioning (HVAC) system may then automatically switch to energy saving mode. Typically, the temperature inside a building may be lowered by several degrees Celsius (for heating cycles) or raised (for cooling cycles) during absences.

To minimize the cost of detecting occupancy and behavioral patterns, it is desirable to rely primarily on meters, sensors, and communication gateways/routers that are installed as part of standard infrastructure. These meters comprise electricity, water, and other meters that are applicable to consumption. Sensors that are part of standard infrastructure may comprise temperature, humidity, carbon dioxide, volatile organic compounds and other sensors as used in ventilation control systems. Communication gateways typically include Internet and home entertainment data gathered for instance from personal computers, from laptops, from smart phones, or from smart television apparatuses.

Via the fusion of meters, of sensors, and of communication gateway data it is possible to gather other useful pieces of information such as
the number of people living in a building,
the lifestyle of those individuals and even what phase of life they are in.

Information about how many and what people occupy a building and about how they behave may in the future be used for purposes such as targeted advertising.

Various approaches to building automation have been commercially available for years. These include NEST™ (http://www.nest.com). NEST™ is a learning thermostat that can be controlled through a phone application. NEST comes with an auto-away feature. That is, NEST uses sensors to detect an individual's presence or absence and accordingly triggers an auto-away program.

Meterplug (http://meterplug.com) offers an intermediate plug with proximity control. As someone walks away with his or her phone, the intermediate plug switches off any appliance connected to it. Meterplug relies on Bluetooth as a wireless link between the phone and the intermediate plug.

Tado™ (http://www.tado.com/de/) determines the position of a phone to control the heating of a building. To save battery life of a phone, the corresponding application relies on the position of the closest radio cell rather than on data from a satellite-based positioning system.

### SUMMARY OF THE INVENTION

It is accordingly an object of the invention to provide a building automation system which overcomes the above-mentioned and other disadvantages of the heretofore-known devices and methods of this general type and which provides advanced building automation systems that meet the aforementioned requirements.

With the foregoing and other objects in view there is provided, in accordance with the invention, a method for automating a building having a standard infrastructure, the method comprising:

acquiring at least one data time history from at least one input device being a part of the standard infrastructure;

averaging the at least one data time history to form an averaged data time history;

arranging the at least one averaged data time history into at least one occupancy pattern, the occupancy pattern covering a given time span;

determining at least one set point from said at least one occupancy pattern of the building or of a part thereof; and

feeding the at least one set point into a system for heating, ventilation, or air-conditioning.

In other words, the present invention is based on the discovery that a building automation system may effectively rely on patterns related to the consumption of electricity and other resources of standard infrastructure to determine lifestyle behavior. Resources of standard infrastructure include, but are not limited to, any resources not directly linked to building automation. Resources not directly linked to building automation comprise Internet gateways, Internet routers, Internet switches, home entertainment equipment, personal computers, laptops, smart phones, or smart television apparatuses. In addition, averaging time histories of consumption patterns improves the reliability of available input data.

It is a related object of the present disclosure to provide a building automation system that allows for averaging of consumption patterns over a time span of several days or weeks.

It is another object of the present disclosure to provide a building automation system that further detects automated events such as watering plants.

It is a related object of the present disclosure to provide a building automation system that has the capacity to filter out automated events such as watering plants.

It is yet another object of the present disclosure to provide a building automation system that is configured to differentiate between absence and presence of people including their activities such as sleep and awake when present.

It is yet another object of the present disclosure to provide a building automation system that recognizes and harnesses temperature, and/or humidity transients, and/or carbon dioxide, and/or volatile organic compounds, and/or noise, and/or other sensor data.

It is yet another object of the present disclosure to provide a building automation system that is configured to differentiate between day and night.

It is yet another object of the present disclosure to provide a building with a building automation system that resolves at least one of the above objects.

Other features which are considered as characteristic for the invention are set forth in the appended claims.

Although the invention is illustrated and described herein as embodied in a building automation system and a related method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram providing a general overview with several components of the building automation system; and

FIG. 2 is a schematic chart showing an example of an occupancy pattern.

### DETAILED DESCRIPTION OF THE INVENTION

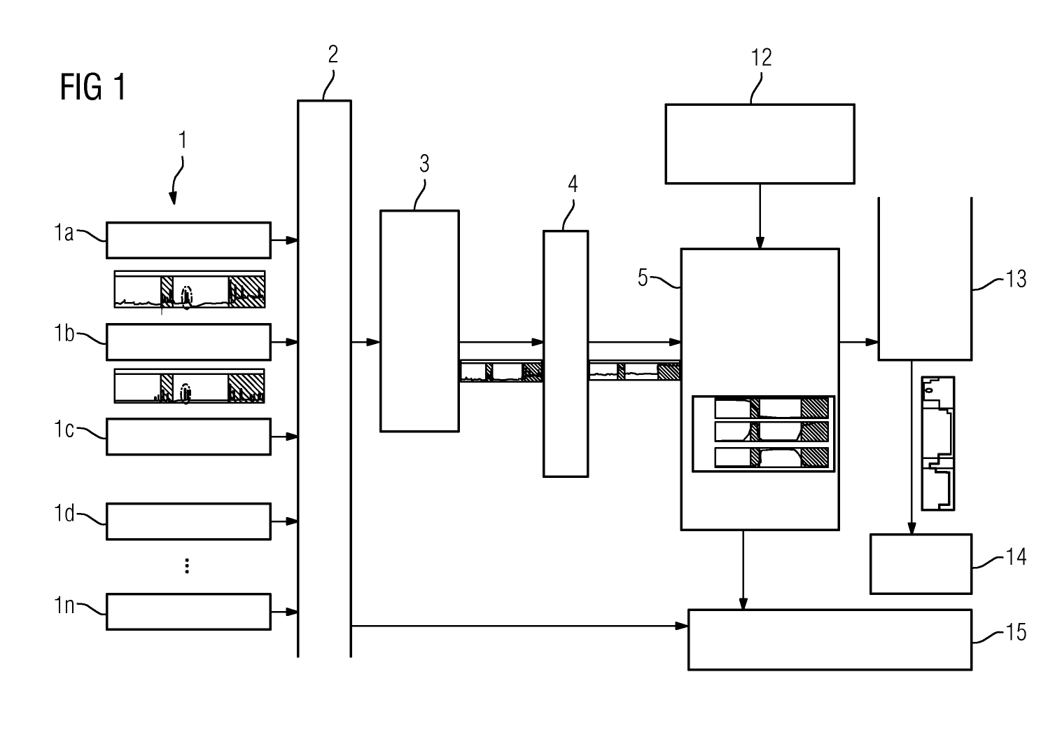

Referring now to the figures of the drawing in detail and first, particularly, to FIG. 1 thereof, there are shown various principal and optional components of the building automation system relating to this description. The system relies on at least one or on a plurality of meter or sensor data time histories 1. FIG.1 shows data time histories 1a, 1b, 1c, 1d, . . . 1n. Each data time history 1a, 1b, 1c, 1d, . . . 1n preferably covers a time span of one day.

The building automation system then combines the data time histories 1a, 1b, 1c, 1d, . . . 1n into a matrix 2 of data time histories. The matrix 2 covers a time span of the past P days, with P being a natural number.

In a subsequent step, possible correlations 3 of different sensor data are examined. The search for correlations 3 primarily aims at filtering out automated processes. Automated processes often affect several data time histories 1a, 1b, 1c, 1d, . . . 1n. They may even affect each time history at the same point time and for the same time span.

A number of additional mechanisms are employed to detect and to filter out automated processes. These mechanisms may either be based on points in time or on typical profiles.

A change of a sensor reading may always or frequently occur at exactly the same point in time. That is, a change of a sensor may occur hourly, daily, or every working day, or only on weekends, or always on the same day during a week. By way of example, a program may water plants on a daily basis every evening at 8 p.m. (20:00 h). By way of another example, a telephone may switch to sleep mode at 11 pm (23:00 h) and thus log off at the WiFi router. This particular pattern indicates that it is more likely that someone is still around and has not left the building yet.

A change of a sensor reading may entail a typical profile. The sensor readings then show a specific known or learned pattern that relates to an automated process or to a specific behavioral pattern. By way of example, the power consumption of a dryer may be detected as a specific pattern by an electricity meter. By way of another example, power and water consumption patterns of a washing machine can be detected simultaneously through an electricity meter and through a water meter. By way of yet another example, a bedtime ritual may involve a typical profile in the form of water consumption for brushing teeth, for using the toilet, and in the form of electricity consumption when the lights in the home are switched off.

More sophisticated approaches to the detection of automated processes can be based on statistical methods such as principal component analysis (PCA) or wavelet analysis. These two methods are known for the detection of anomalies such as anomalous network traffic. PCA starts from the assumption that data from different sensors are correlated. In other words, an individual's behavior inside a building is diverse and causes changed readings in a plurality of sensors over a specific time period. By way of example, someone at home switches on and off various appliances. Consequently, electricity and water consumption will change when that person washes hands or does cooking. Likewise Internet data traffic as registered by a router will change due to Internet based television, Internet radio, web surfing, email, etc. Automated processes may as well change some sensor readings while leaving other readings unaffected. PCA is a transformation that maps a set of data points on a new axis, i.e., on principal components. A threshold can then be set to differentiate between normal human behavior and automated processes.

After the removal of automated processes 3, the data time histories 1a, 1b, 1c, 1d, . . . 1n of the matrix 2 are averaged 4 over P days, with P being a natural number. In a preferred embodiment, averaging takes place over a number of similar days such as Tuesdays. The occupancy pattern to be determined from the averaged data then becomes a little more distinct and recognizable.

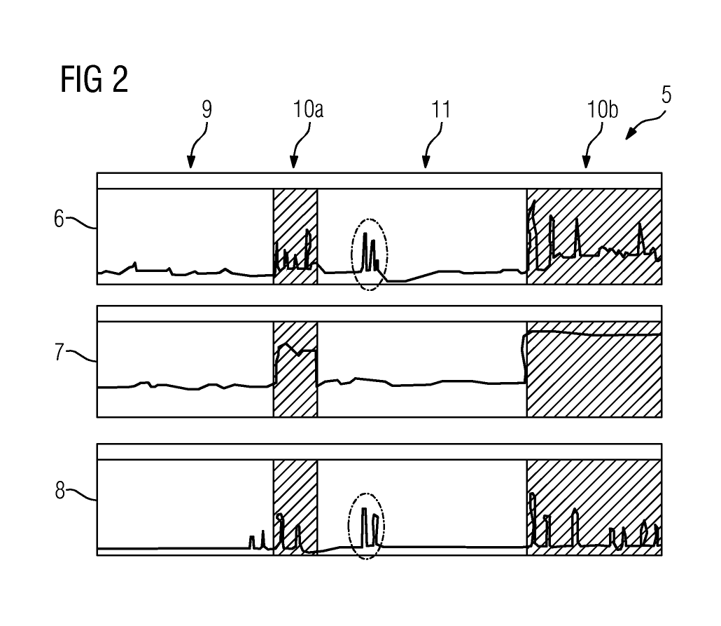

Subsequently, occupancy patterns 5 are gathered for every day of the week. Referring now to FIG. 2, there is provided an example of an occupancy pattern 5. Occupancy patterns 5 are plots of at least one sensor reading 6, 7, 8 over time for a given day of the week. By way of example, averaged readings from an electricity meter 6, 7 for every Wednesday form an occupancy pattern. Occupancy patterns may also involve readings from more than one sensor or meter and/or combined readings from more than one sensors or meter. Based on these plots, it is frequently possible to differentiate between periods when someone is home and sleeping 9, when an individual is home and active 10, or when that person is absent 11.

By way of example, the upper curve 6 of FIG. 2 shows the readings of an electricity meter of a typical Thursday. That particular day is subdivided into periods of sleep 9, of absence 11, and of times when an occupant is awake and at home 10.

At the simplest level, differentiation between home and sleeping 9, home and active 10, and absence 11, is used as a basis for setting temperatures inside building. The temperatures may, for instance, be set to 19 degrees Celsius (66 F) during period 9, to 22 degrees Celsius (72 F) during period 10, and to 17 degrees Celsius (63 F) during absence (period 11).

On a more sophisticated level, mathematical methods such as fuzzy logics and neural networks are employed to derive a profile of probabilities for a given occupancy state. In the example given above, a profile of probabilities involves the probabilities of an occupancy state at any point in time of each of the states (periods) 9, 10, 11. A temperature inside a building may then be set in accordance with the expected current state and its probability of occurrence at any point in time. By way of example, in a winter heating cycle, the temperature inside a building would start increasing before the occupants arrive home in the evening. The temperature would start increasing since there is, at any given time, a certain probability for the occupants to be home earlier than predicted by the average time for arriving home.

Sensor fusion is another approach known for its capacity to combine signals from different sensors into one signal. The new signal should then be better than each individual signal. The term better means more accurate, or more complete, or fewer missing data points, or any combination thereof. By way of example, a combination of signals from an electricity meter and from a water meter could lead to a new signal that is less noisy. The new signal could also cover those points in time when precise measurements from a water meter are missing.

Turning once more to FIG. 1, the occupancy patterns 5 may also be enhanced by typical behavior patterns 12. Electricity 6, 7 and water meter 8 readings are minimal data that frequently show similar patterns of consumption. It can thus be difficult to judge on whether an occupant is at home sleeping 9, at home and active 10, or absent 11 based only on electricity 6, 7 and on water meter 8 readings. And yet the home and sleeping period 9 will be at night in most households. Likewise, the absence period 11 will occur during the day. Personnel working night shifts would be an exception to this rule. Typical behavior provides an adequate basis for a starting assumption for most residential buildings. In addition, the period of sleeping at home 9 will typically be shorter (5 to 8 hours) than the period of absence 11 (8 to 12 hours). Data from typical behavioral patterns may therefore be used to judge whether a given period of inactivity is more likely to be a sleep period 9 or more likely due to be an absence 11.

Also, patterns for getting up 10a and for arriving home 10b typically show differences. The first period of activity at home 10a typically lasts for up to two hours, whereas the period after arriving home 10b typically last longer (2 to 8 hours). Water usage also shows distinct characteristics in any of those periods 10a, 10b. People have a tendency to wash, shower, shave, flush toilets more often in the morning than at other times of the day.

Temperature and humidity transients form yet another useful indication to distinguish periods of active presence 10a, 10b from other periods 9, 11. A rapid increase in temperature (or in humidity) may, for instance, indicate showering or bathing. Likewise, a rapid decrease in temperature may point to the opening of windows or doors. A rapid increase in both temperature and in humidity is yet another indicator of active presence, as it may indicate that someone is cooking.

In a special embodiment, the building automation system also relies on algorithmic enhancements 13. The temperature inside a building may be intelligently adapted to higher granularity than just three states such as home and sleeping 9, active presence 10, and absence 11. With added granularity, the temperature could be slightly higher when occupants first wake as they are typically not yet dressed and prefer their home to be warm. Later, whist having breakfast and rushing around before leaving for work, the temperature inside the building would be lowered by 1 degree Celsius. Similarly, when first arriving home from the cold outdoors the comfort temperature may be moderate. Later, when everyone is watching TV or reading, temperature will be raised.

Should the above pattern not be the optimum in terms of comfort, then occupants have an opportunity to request an increase or a decrease in temperature. The control system may actually learn from these inputs.

The building automation system may not only be used to control heating. The disclosed system can also be used to control air conditioning and ventilation. In other words, the building automation system can be used to control the entire heating, ventilation, and air condition scheme 14 of a building. The system may also be used for other purposes such as assisted living 15.

Any steps of a method according to the present application may be embodied in hardware, in a software module executed by a processor, or in a cloud computer, or in a combination of these. The software may include a firmware, a hardware driver run in the operating system, or an application program. Thus, the invention also relates to a computer program product for performing the operations presented herein. If implemented in software, the functions described may be stored as one or more instructions on a computer-readable medium. Some examples of storage media that may be used include random access memory (RAM), read only memory (ROM), flash memory, EPROM memory, EEPROM memory, registers, a hard disk, a removable disk, other optical disks, or any available media that can be accessed by a computer or any other IT equipment and appliance.

It should be understood that the foregoing relates only to certain embodiments of the invention and that numerous changes may be made therein without departing from the spirit and the scope of the invention as defined by the following claims. It should also be understood that the invention is not restricted to the illustrated embodiments and that various modifications can be made within the scope of the following claims.

The following is a summary list of reference numerals and the corresponding structure used in the above description of the invention:
1 plurality of meter or sensor data time histories 1a, 1b, 1c, 1d, . . . 1n individual time histories
2 matrix of time histories
3 filter out automated processes
4 averaging
5 occupancy pattern
6, 7 electricity meter readings
8 water meter reading
9 home and sleeping period
10a, 10b period of active presence
11 period of absence
12 typical behavior patterns
13 algorithmic enhancements
14 heating, ventilation, air conditioning
15 assisted living

1. A method for automating a building having a standard infrastructure, the method comprising:
acquiring at least one data time history from at least one input device being a part of the standard infrastructure;
averaging the at least one data time history to form an averaged data time history;
arranging the at least one averaged data time history into at least one occupancy pattern, the occupancy pattern covering a given time span;
determining at least one set point from said at least one occupancy pattern of the building or of a part thereof; and
feeding the at least one set point into a system for heating, ventilation, or air-conditioning.

2. The method for automating a building according to claim 1, which comprises acquiring the at least one data time history from one or more devices selected from the group consisting of a meter, a sensor, a switch, and an Internet gateway.

3. The method for automating a building according to claim 1, which comprises acquiring the at least one data time history from one or more devices selected from the group consisting of an electricity meter, a water meter, a smart electricity meter, an Internet router, a WiFi router, a networked device, a temperature sensor, a humidity sensor, and a light sensor.

4. The method for automating a building according to claim 1, which comprises acquiring a plurality of data time histories.

5. The method for automating a building according to claim 1, which further comprises filtering automated processes out of the at least one data time history.

6. The method for automating a building according to claim 5, wherein the filtering step comprises employing principal component analysis, and/or wavelet analysis, and/or sensor fusion for filtering the automated processes out of the at least one data time history.

7. The method for automating a building according to claim 1, which further comprises enhancing the at least one occupancy pattern through typical behavior patterns.

8. The method for automating a building according to claim 7, wherein the enhancing step relies on a day-night pattern.

9. The method for automating a building according to claim 1, which further comprises a step of obtaining a finer level of granularity of the at least one set point through an algorithmic enhancement.

10. The method for automating a building according to claim 9, wherein the algorithmic enhancement raises or lowers the at least one set point.

11. The method for automating a building according to claim 1, which comprises determining a plurality of set points from the occupancy pattern.

12. The method for automating a building according to claim 1, wherein the at least one set point is a temperature value, or a humidity value, or a luminosity value, or a fan speed of a ventilation system, or a concentration of carbon dioxide, or a concentration of volatile organic compounds.

13. The method for automating a building according to claim 1, which further comprises feeding the at least one set point into a system for assisted living, a system for home safety, or a building automation system.

14. A non-transitory, tangible computer-readable medium having computer-executable instructions executable by a processor for performing the method according to claim 1 when the instructions are executed.

15. A building automation system, comprising:
an acquisition device for acquiring at least one data time history from at least one input device, the at least one input device being a part of standard infrastructure;
a device connected to said acquisition device and configured to average the at least one data time history and to form at least one averaged data time history;
a patterning device configured to arrange the at least one averaged data time history into at least one occupancy pattern of the building or of a part thereof, the at least one occupancy pattern covering a given time span;
means for determining at least one set point from the occupancy pattern; and
a device for feeding the at least one set point into a system for heating, ventilation, or air-conditioning.
